(19) United States
(12) Patent Application Publication
(10) Pub. No.: US 2015/0277615 A1
(43) Pub. Date: Oct. 1, 2015

(54) Touch Module and Display Device Using the Same

(71) Applicant: Top Victory Investments Ltd., Kowloon (HK)

(72) Inventors: Wei-Ting LIN, New Taipei City (TW); William CHENG, New Taipei City (TW); Yung-Shin LlOU, New Taipei City (TW)

(73) Assignee: Top Victory Investments Ltd., Kowloon (HK)

(21) Appl. No.: 14/224,181

(22) Filed: Mar. 25, 2014

(51) Int. Cl. G06F 3/044

(52) U.S. Cl. CPC G06F 3/044; G06F 2203/04111

(57) ABSTRACT

The present invention provides a touch module and a display device using the same. The touch module comprises a plastic substrate plate, a first line pattern, an optical substrate, and a second line patter. The first line pattern is formed on the plastic substrate plate. The optical substrate is adjacent to the plastic substrate plate and covers on the first line pattern. The second line pattern is adjacent to the optical substrate. The first and the second line patterns are not connected to each other. The invention replaces glass with the plastic substrate. Comparing to the prior art, the invention reduces weight and cost and increases the durability.

### BACKGROUND OF THE INVENTION

1. Field of the Invention

The present invention relates to a touch module and a display device using the same and, more particularly, to a capacitive touch module and a display device using the same.

2. Description of the Prior Art

Practical applications of touch modules are becoming more developing and prosperous along with popularizing of smart phones and tablet computers. Recently, laptop computers with touch function become the mainstream. More and more desktop computers and smart TVs with larger display panels also comprise touch modules. A touch module could be applied with different kinds of technologies like resistive, capacitive, acoustic, and optical technologies. According to demands of multi-touch control and consideration of the cost of fabrication and the precision of touch control, capacitive touch modules become the most mature application so far.

Generally, a capacitive touch module comprises a cover glass, a substrate plate, a sensing line pattern, and a driving line pattern. The sensing line pattern and the driving line pattern are formed on the substrate plate. The substrate plate could be a strengthened glass, a mother glass, or a plastic film (e.g. a PET film). Regarding to the structure of the capacitive touch module aforementioned, the touch module should include at least one layer of glass (i.e. the cover glass). Glass is fragile and is easily damaged either during fabricating or using. Glass also causes much more weight when it is applied to a product. For a portable product, more weight means less convenient with regard to using and carrying. For a product with a large display panel, e.g. a laptop computer, a desktop computer, or a TV, a large glass plate needed to be applied to the lager display panel is easily distorted because of stress; therefore, a thickness of the large glass plate needs to be increased accordingly to overcome distortion, which causes negative effect with regard to its weight and cost.

### SUMMARY OF THE INVENTION

According to the shortage of the prior art, the present invention aims to provide a touch module and a display device using the same so as to reduce weight and cost and to increase durability.

According to a claimed invention, the touch module comprises a plastic substrate plate, a first line pattern, an optical substrate, and a second line pattern. The first line pattern is formed on the plastic substrate plate. The optical substrate is adjacent to the plastic substrate plate and covers the first line pattern. The second line pattern is adjacent to the optical substrate. The first line pattern and the second line pattern are not connected to each other.

According to an embodiment of the claimed invention, the second line pattern is formed on a surface of the optical substrate opposite to the plastic substrate plate.

According to an embodiment of the claimed invention, the optical substrate includes a plastic film attached to the plastic substrate plate.

According to an embodiment of the claimed invention, the optical substrate includes an insulating coating applied to the plastic substrate plate.

According to an embodiment of the claimed invention, the second line pattern is formed on the plastic substrate plate, is intersected with the first line pattern to form a plurality of intersecting areas, and is cut on each of the intersecting areas to form two cut ends to be normally open. The optical substrate covers the first line pattern and the second line pattern, and includes a plurality of contact windows respectively aligned with the intersecting areas. A conducting substrate is disposed on and across every two of the contact windows, and is electrically connected to the two cut ends of the second line pattern.

According to an embodiment of the claimed invention, the touch module further comprises a receiver and a driver. The receiver is electrically connected to one of the first line pattern and the second line pattern, and the driver is electrically connected to the other one of the first line pattern and the second line pattern.

According to an embodiment of the claimed invention, the touch module further comprises a cable. The cable is electrically connected to the first line pattern and the second line pattern.

According to an embodiment of the claimed invention, the first line pattern and the second line pattern respectively include bonding pads. The cable is respectively electrically connected to the bonding pads.

According to an embodiment of the claimed invention, the cable includes a flexible printed circuit. An anisotropic conductive film is disposed between the cable and the bonding pad.

According to the claimed invention, the display device comprises a display panel, a plastic substrate plate, a first line pattern, an optical substrate, and a second line pattern. The first line pattern is formed on the plastic substrate plate. The optical substrate is adjacent to the plastic substrate plate and covers the first line pattern. The second line pattern is adjacent to the optical substrate. The first line pattern and the second line pattern are not connected to each other, and the optical substrate is adjacent to the display panel.

According to an embodiment of the claimed invention, the optical substrate is attached to the display panel with a full lamination process.

The present invention which provides the touch module and the display device replaces glass with the plastic substrate plate. Comparing to the prior art, the invention reduces weight and cost and increases durability.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram of a touch display device according to a preferred embodiment of the present invention.

FIG. 2 is a partial enlarged diagram of a first line pattern and a second line pattern according to the preferred embodiment of the present invention.

FIG. 3 is an enlarged cross-sectional diagram of a touch module according to the preferred embodiment of the present invention.

FIG. 4 is an enlarged cross-sectional diagram of a touch module according to another embodiment of the present invention.

### DETAILED DESCRIPTION

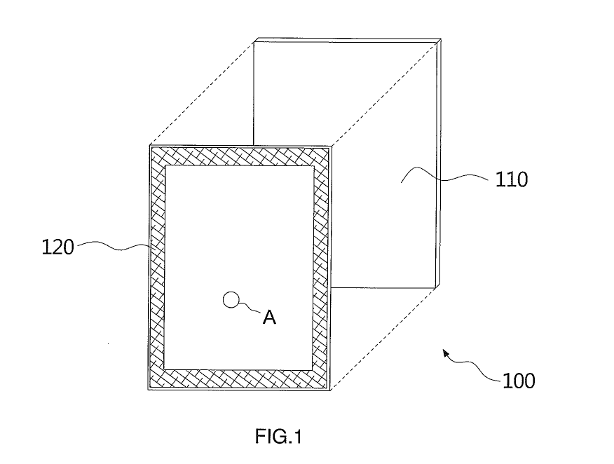

Please refer to FIG. 1. FIG. 1 illustrates a diagram of a touch display device according to a preferred embodiment of the present invention. A display device 100 comprises a display panel 110 and a touch module 120. The display panel 110 is, but is not limited to, a thin film transistor liquid crystal display (TFT-LCD). The display device 100 can be a screen portion of a smart phone, a tablet computer, a laptop computer, a desktop computer, or a smart TV. The touch module 120 is disposed in front of and is adjacent to the display panel 110. When a user touches an image displayed on the display panel 110, the user actually touches lines on the touch module 120; therefore, a location on which is touched can be derived by the touch module 120, and corresponding signals can be generated and be transmitted to a backend processing module so as to stimulate corresponding touch control.

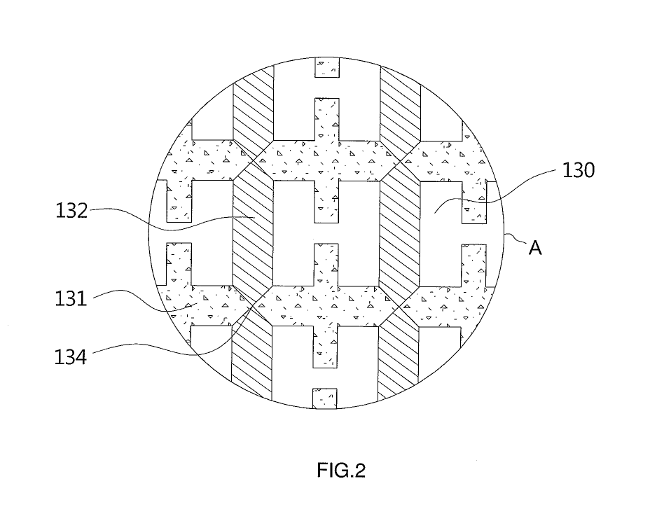

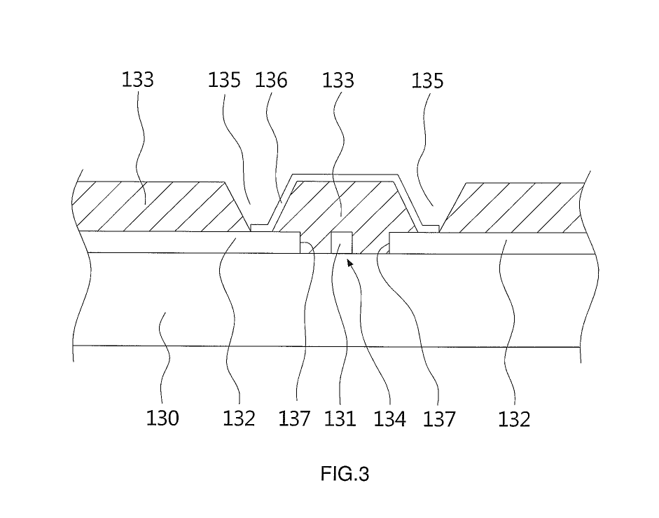

Please refer to FIG. 2 and FIG. 3. FIG. 2 illustrates a partial enlarged diagram of a first line pattern and a second line pattern according to the preferred embodiment of the present invention, which is enlarged from the portion A as shown in FIG. 1. FIG. 3 illustrates an enlarged cross-sectional diagram of the touch module 120 according to the preferred embodiment of the present invention, which corresponds to the portion A. The touch module 120 comprises a plastic substrate plate 130, a first line pattern 131, a second line pattern 132, and an optical substrate 133. The first line pattern 131 is formed on the plastic substrate plate 130. The optical substrate 133 is adjacent to the plastic substrate plate 130 and is covered the first line pattern 131. The second line pattern 132 is adjacent to the optical substrate 133. The first line pattern 131 and the second line pattern 132 are not electrically connected to each other.

In the embodiment, the second line pattern 132 is also formed on the plastic substrate plate 130. In other words, the first line pattern 131 and the second line pattern 132 are formed on the same surface of the plastic substrate plate 130. The first and the second line patterns 131, 132 are intersected with each other to form a plurality of intersecting areas 134, as shown in FIG. 2. The first and the second line patterns 131, 132 can be, but are not limited to, formed by an indium tin oxide (ITO) film with a photo-etching process.

As shown in FIG. 3, the second line pattern 132 is cut on each of the intersecting areas 134 to form two cut ends 137 to be normally open, wherein the first line pattern 131 extends along a direction perpendicular to the diagram of FIG. 3; therefore, the second line pattern 132 shall not be electrically connected to the first line pattern 131. The optical substrate 133 covers the first and the second line patterns 131, 132. In the embodiment, the optical substrate 133 is an insulating coating applied to the plastic substrate plate 130. The optical substrate 133 includes a plurality of contact windows 135 respectively aligned with the intersecting areas 134. More specifically, the contact window 135 passes through and is disposed on a spot of the optical substrate 133 corresponding to the cut end 137, and a conducting substrate 136 is disposed on and across every two of the contact windows 135. The conducting substrate 136 can be a bridge formed by an ITO film. The conducting substrate 136 is electrically connected to the two cut ends 137 of the second line pattern 132 to make the second line pattern 132 become capable of conducting, and meanwhile the second line pattern 132 is not electrically connected to the first line pattern 131. A surface of the optical substrate 133 opposite to the plastic substrate plate 130 is attached to the display panel 110 with a full lamination process. The full lamination is also known as a non-air-gap design. Namely, there between the display panel 110 and the surface of the optical substrate 133 has no gap with air. The plastic substrate plate 130 can be a cover/protect plate of the touch module 120.

One of the first and the second line patterns 131, 132 is electrically connected to a receiver (not shown), e.g. a sensor. The other one of the first and the second line patterns 131, 132 is electrically connected to a driver (not shown). For example, the first line pattern 131 is electrically connected to the receiver, and the second line pattern 132 is electrically connected to the driver. During operation of the touch module 120, input current from the driver continuously flows through the second line pattern 132, and a particular amount of charges are continuously excited on the first line pattern 131 near every intersecting area 134 because of projection of electric fields, and are sensed by the receiver in a particular form of signals. When a user touches the touch module 120, an electric field of a touched intersecting area 134 changes, and an amount of charges on the first line pattern 131 near the touched intersecting area 134 are accordingly changes, such that the receiver will sense a changed signal and will transmit it to the backend processing module; therefore, the location on which is touched by the user can be derived, so as to implement the function of touch control.

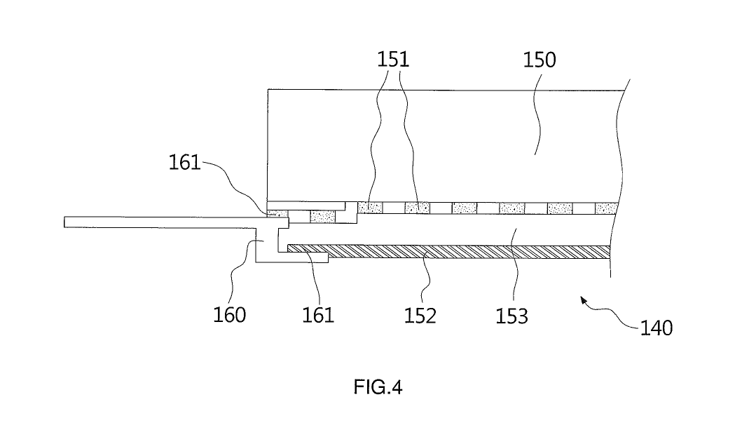

Please refer to FIG. 4. FIG. 4 illustrates an enlarged cross-sectional diagram of a touch module according to another embodiment of the present invention, which is based on the display device 100 of FIG. 1. The touch module 140 comprises a plastic substrate plate 150, a first line pattern 151, a second line patter 152, and an optical substrate 153. The first line pattern 151 is formed on the plastic substrate plate 150. The optical substrate 153 is adjacent to the plastic substrate plate 150 and covers the first line pattern 151. The second line pattern 152 is adjacent to the optical substrate 153. The first line pattern 151 and the second line pattern 152 are not connected to each other. In the embodiment, the second line pattern 152 is formed on a surface of the optical substrate 153 opposite to the plastic substrate plate 150. Namely, the first and the second line patterns 151, 152 are not formed on the same surface. More specifically, the optical substrate 153 is a thin plastic film, e.g. a PET film. After the first line pattern 151 was formed on the plastic substrate plate 150, and the second line pattern 152 was formed on the optical substrate 153, then the optical substrate 153 is attached to the plastic substrate plate 150. In other words, the optical substrate 153 is sandwiched between the first and the second line patterns 151, 152, but projections of the first and the second line patterns 151, 152 on a projecting plane are still intersected with each other. In other embodiment, the optical substrate can be an insulating coating. After the first line pattern was formed on the plastic substrate plate, first the insulating coating is applied to the plastic substrate plate and covers the first line pattern, and then the second line pattern is formed on the insulating coating.

The touch module 140 further comprises a receiver and a driver (not shown). In the embodiment, the receiver is, but is not limited to, electrically connected to the first line pattern 151, and the driver is, but not limited to, electrically connected to the second line pattern 152. The touch module 140 further comprises a cable 160. The cable 160 includes a flexible printed circuit (FPC). The first and the second line patterns 151, 152 respectively include bonding pads 161. During manufacturing, parts of the optical substrate 153 covering on the bonding pads 161 need to be stripped first to expose the bonding pads 161, and then the cable 160 is electrically connected to the bonding pads 161 of the first and the second line patterns 151, 152. The cable 160 is electrically connected to the bonding pad 161 by, but not limited to, an anisotropic conductive film (ACF), which is disposed between the cable 160 and the bonding pad 161. In the embodiment, the optical substrate 153 of the touch module 140 is attached to the display panel 110 with a full lamination process. The plastic substrate plate 150 can be a cover/protect plate of the touch module 140.

The present invention which provides the touch module and the display device replaces glass with the plastic substrate plate. Comparing to the prior art, the invention reduces weight and cost and increases durability.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A touch module comprising:
a plastic substrate plate;
a first line pattern formed on the plastic substrate plate;
an optical substrate adjacent to the plastic substrate plate and covering the first line pattern; and
a second line pattern adjacent to the optical substrate, wherein the first line pattern and the second line pattern are not connected to each other.

2. The touch module of claim 1, wherein the second line pattern is formed on a surface of the optical substrate opposite to the plastic substrate plate.

3. The touch module of claim 2, wherein the optical substrate includes a plastic film attached to the plastic substrate plate.

4. The touch module of claim 2, wherein the optical substrate includes an insulating coating applied to the plastic substrate plate.

5. The touch module of claim 1, wherein the second line pattern is formed on the plastic substrate plate, is intersected with the first line pattern to form a plurality of intersecting areas, and is cut on each of the intersecting areas to form two cut ends to be normally open, wherein the optical substrate covers the first line pattern and the second line pattern, and includes a plurality of contact windows respectively aligned with the intersecting areas, wherein a conducting substrate is disposed on and across every two of the contact windows, and is electrically connected to the two cut ends of the second line pattern.

6. The touch module of claim 1 further comprising a receiver and a driver, wherein the receiver is electrically connected to one of the first line pattern and the second line pattern, and the driver is electrically connected to the other one of the first line pattern and the second line pattern.

7. The touch module of claim 6 further comprising a cable, wherein the cable is electrically connected to the first line pattern and the second line pattern.

8. The touch module of claim 7, wherein the first line pattern and the second line pattern respectively include bonding pads; the cable is electrically connected to the bonding pads.

9. The touch module of claim 8, wherein the cable includes a flexible printed circuit; an anisotropic conductive film is disposed between the cable and the bonding pad.

10. A display device comprising:
a display panel;
a plastic substrate plate;
a first line pattern formed on the plastic substrate plate;
an optical substrate adjacent to the plastic substrate plate and covering the first line pattern; and
a second line pattern adjacent to the optical substrate, wherein the first line pattern and the second line pattern are not connected to each other, and the optical substrate is adjacent to the display panel.

11. The display device of claim 10, wherein the optical substrate is attached to the display panel with a full lamination process.

12. The display device of claim 10, wherein the second line pattern is formed on a surface of the optical substrate opposite to the plastic substrate plate.

13. The display device of claim 12, wherein the optical substrate includes a plastic film attached to the plastic substrate plate.

14. The display device of claim 12, wherein the optical substrate includes an insulating coating applied to the plastic substrate plate.

15. The display device of claim 10, wherein the second line pattern is formed on the plastic substrate plate, is intersected with the first line pattern to form a plurality of intersecting areas, and is cut on each of the intersecting areas to form two cut ends to be normally open, wherein the optical substrate covers the first line pattern and the second line pattern, and includes a plurality of contact windows respectively aligned with the intersecting areas, wherein a conducting substrate is disposed on and across every two of the contact windows, and is electrically connected to the two cut ends of the second line pattern.

16. The display device of claim 10 further comprising a receiver and a driver, wherein the receiver is electrically connected to one of the first line pattern and the second line pattern, and the driver is electrically connected to the other one of the first line pattern and the second line pattern.

17. The display device of claim 16 further comprising a cable, wherein the cable is electrically connected to the first line pattern and the second line pattern.

18. The display device of claim 17, wherein the first line pattern and the second line pattern respectively include bonding pads; the cable is respectively electrically connected to the bonding pads.

19. The display device of claim 18, wherein the cable includes a flexible printed circuit; an anisotropic conductive film is disposed between the cable and the bonding pad.
